(19) United States
(12) Patent Application Publication
(10) Pub. No.: US 2006/0079120 A1
(43) Pub. Date: Apr. 13, 2006

(54) Interface and control devices for display apparatus and integrated circuit chip having the same

(76) Inventors: Seung-Woo Lee, Seoul (KR); Tae-Sung Kim, Suwon-si (KR)

Correspondence Address: CANTOR COLBURN, LLP, 55 GRIFFIN ROAD SOUTH, BLOOMFIELD, CT, 06002, US

(21) Appl. No.: 11/075,267

(22) Filed: Mar. 8, 2005

(30) Foreign Application Priority Data
Oct. 8, 2004 (KR) 2004-80530

(51) Int. Cl. H01R 12/24

(52) U.S. Cl. 439/497

(57) ABSTRACT

In an interface device between a connector and a digital serial bus, a control device for a display apparatus and an integrated circuit chip, the interface device includes a non-connection pin connecting circuit and a ground pin connecting circuit. The non-connection pin connecting circuit electrically connects a non-connection pin of a connector to a first line of a digital serial bus. The ground pin connecting circuit receives a control signal applied to the ground pin connecting circuit through a first ground pin of the connector. The ground pin connecting circuit controls electrical connection between a second ground pin of the connector and a second line of the digital serial bus in response to the control signal. Therefore, a structure of the interface device is simplified.

### BACKGROUND OF THE INVENTION

1. Field of the Invention

The present invention relates to an interface device, a control device for a display apparatus and an integrated circuit chip having the interface device. More particularly, the present invention relates to an interface device between a connector and a digital serial bus, which has a simplified structure, a control device for a display apparatus employing the interface device, and an integrated circuit chip having the interface device.

2. Description of the Related Art

Recently, there has been a desire to reduce weight and size of electronic apparatuses such as a monitor, a laptop computer, a television receiver set, a mobile communication terminal, etc. In addition, there has been a similar desire to reduce weight and size of display apparatuses. To achieve the above-mentioned desires, a flat panel display apparatus that is thinner than a cathode ray tube (CRT) display apparatus has been widely used.

In a liquid crystal display (LCD) apparatus, which is a type of flat panel display apparatus, generally, a liquid crystal arrangement is varied in response to an electric field applied thereto, and thus a light transmittance thereof may be changed to display images.

The LCD apparatus includes modules such as a timing controller (T-CON), an electrically erasable programmable read-only memory (EEPROM), a digital variable register (DVR), etc. The modules apply control signals to an LCD panel, and store operation data that are used for operating the LCD apparatus. The modules are formed in a printed circuit board (PCB) as integrated circuits (IC). The modules are coupled to one another through a bus so that signals are transferred via the bus.

An example of a standard bus is an inter IC (I2C) bus. The I2C bus is an interactive digital serial bus. The I2C bus includes two lines that transmit serial data (SDA) and a serial clock signal (SCL), respectively.

The LCD apparatus includes a connector that functions as an interface for transmitting input data and output data that are provided from an external system. The external system applies a data signal and a control signal to the LCD apparatus through the connector.

Number of pins of the connecter is decreased so that a structure of the digital interface may be simplified. Panel standardization working group (PSWG) for a super extended graphic array (SXGA) of a display panel of seventeen inches standardized the number of the pins of the connector to be thirty in the Year 2003.

FIG. 1 is a circuit diagram showing thirty pins of a connector of an LCD apparatus standardized by PSWG. The connector 30 includes thirty pins. Data signals or clock signals are applied from an external system 10 to an internal device 20 through first to twenty fourth pins that represent data input pins or clock input pins.

The first pin RXO0−, the second pin RXO0+, the third pin RXO1−, the fourth pin RXO1+, the fifth pin RXO2−, the sixth pin RXO2+, the tenth pin RXO3−, the eleventh pin RXO3+, the twelfth pin RXE0−, the thirteenth pin RXE0+, the fifteenth pin RXE1−, the sixteenth pin RXE1+, the eighteenth pin RXE2−, the nineteenth pin RXE2+, the twenty second pin RXE3−, and the twenty third pin RXE3+receive the data signals. The seventh, fourteenth, seventeenth and twenty fourth pins GND are ground pins. The eighth pin RXOC−, the ninth pin RXOC+, the twentieth pin RXEC− and the twenty first pin RXEC+ receive the clock signals.

‘Receiver’, ‘Odd’ and ‘Even’ are represented by ‘RX’, ‘O’ and ‘E’, respectively. The connector 30 includes the RXO pins and the RXE pins that are grouped into different groups so that the signals are transmitted in a dual method to increase a bandwidth of the signals.

The twenty fifth to twenty seventh pins are two ground pins GND and a non-connection pin NC. The twenty eighth to thirtieth pins are reference voltage pins VDD. The conventional connector had three NC pins, however, the number of NC pins has been decreased in the thirty pin connector standardized by PSWG, so that the connector 30 has usually one NC pin allocated to twenty sixth pin.

When the number of the NC pins is decreased so as to simplify the digital interface, a functioning ability of the connector 30 may be restricted. The I2C bus includes the SDA line and the SCL line. When the SDA line and the SCL line are not coupled to the external system 10, the SDA line and the SCL line need to be activated by applying high level signals that correspond to active levels to the SDA line and the SCL line via pull up resistors. Therefore, the SDA line and the SCL line need to be electrically coupled to the NC pins, respectively, to allow independent operation of the I2C bus.

However, since the standard thirty pin connector 30 typically has no more than one NC pin(twenty sixth pin), one of the SDA line and the SCL line is electrically coupled to the NC pin, and the other of the SDA line and the SCL line is electrically coupled to one of the GND pins (the twenty fifth pin or the twenty seventh pin). Alternatively, the other of the SDA line and the SCL line may be disconnected from one of the GND pins of the connector 30.

When either the SDA line or the SCL line is electrically coupled to the GND pin, the line that is electrically coupled to the GND pin has a ground potential so that the IC2 bus may not be independently operated. When either the SDA line or the SCL line is disconnected from the GND pin, the I2C bus may be operated independently, however, the internal device 20 is disconnected from an external I2C bus of the external system 10. Thus, the internal device 20 is not coupled to the external system 10.

The I2C bus of the internal device 20 may not be electrically coupled to the external system 10 when the connector has only one NC pin. Therefore, there was a need to develop an interface device to allow coupling of the external system 10 to the internal device 20 for operation or testing of the internal device 20 when the number of the NC pins of the connector 30 is one or zero.

### BRIEF SUMMARY OF THE INVENTION

The present invention provides an interface device between a connector and a digital serial bus, which has a simplified structure. The present invention also provides a control device for a display apparatus having the interface device. The present invention also provides an integrated circuit chip having the interface device.

An interface device between a connector and a digital serial bus in accordance with an aspect of the present invention includes a non-connection pin connecting circuit and a ground pin connecting circuit. The non-connection pin connecting circuit electrically connects a non-connection pin of the connector to a first line of the digital serial bus. The ground pin connecting circuit receives a control signal applied to the ground pin connecting circuit through a first ground pin of the connector. The ground pin connecting circuit controls electrical connection between a second ground pin of the connector and a second line of the digital serial bus in response to the control signal.

An interface device between a connector and a digital serial bus in accordance with another aspect of the present invention includes a first ground pin connecting circuit and a second ground pin connecting circuit. The first ground pin connecting circuit receives a signal applied to the first ground pin connecting circuit through a first ground pin of the connector. The first ground pin connecting circuit controls electrical connection between a second ground pin of the connector and a first line of the digital serial bus. The second ground pin connecting circuit receives the signal applied to the second ground pin connecting circuit through the first ground pin of the connector. The second ground pin connecting circuit controls electrical connection between the third ground pin of the connector and the second line of the digital serial bus.

A control device for a display apparatus in accordance with an aspect of the present invention includes a connector, a digital serial bus, modules and an interface device. The connector includes a first ground pin, a non-connection pin and a second ground pin. The digital serial bus includes a first line and a second line. The modules are electrically coupled to the first and second lines of the digital serial bus. The modules generate a control signal and set operation data. The interface device includes a non-connection pin connecting circuit and a ground pin connecting circuit. The non-connection pin connecting circuit electrically connects the non-connection pin to the first line. The ground pin connecting circuit receives a signal applied to the ground pin connecting circuit through a first ground pin of the connector, the ground pin connecting circuit controls electrical connection between the second ground pin of the connector and the second line of the digital serial bus in response to the signal from the first ground pin.

A control device for a display apparatus in accordance with another aspect of the present invention includes a connector, a digital serial bus, modules and an interface device. The connector includes a first ground pin, a second ground pin and a third ground pin. The digital serial bus includes a first line and a second line. The modules are electrically coupled to the first and second lines of the digital serial bus. The modules generate a control signal and set operation data. The interface device includes a first ground pin connecting circuit and a second ground pin connecting circuit. The first ground pin connecting circuit receives a signal applied to the first ground pin connecting circuit through a first ground pin of the connector. The first ground pin connecting circuit controls electrical connection between a second ground pin of the connector and a first line of the digital serial bus. The second ground pin connecting circuit receives the signal applied to the second ground pin connecting circuit through the first ground pin of the connector, the second ground pin connecting circuit controls electrical connection between a third ground pin of the connector and a second line of the digital serial bus.

An integrated circuit chip in accordance with an aspect of the present invention includes a memory, a control input pin, a first signal input pin, a second signal input pin, a digital serial bus controlling circuit and a switching circuit. The control input pin is electrically coupled to a first ground pin of a connector. The first signal input pin is electrically coupled to a non-connection pin of the connector. The second signal input pin is electrically coupled to a second ground pin of the connector. The digital serial bus controlling circuit is electrically coupled to the control input pin, the first signal input pin, the second signal input pin, and the memory. The switching circuit is disposed between the first signal input pin and the digital serial bus controlling circuit so that the switching circuit controls the electrical connection between the first signal input pin and the digital serial bus controlling circuit based on a signal. The signal is applied to the switching circuit through the control input pin.

An integrated circuit chip in accordance with another aspect of the present invention includes a memory, a control input pin, a first signal input pin, a second signal input pin, a digital serial bus, a first switching circuit and a second switching circuit. The control input pin is electrically coupled to a first ground pin of a connector. The first signal input pin is electrically coupled to a second ground pin of the connector. The second signal input pin is electrically coupled to a third ground pin of the connector. The digital serial bus controlling circuit is electrically coupled to the control input pin, the first signal input pin, the second signal input pin, and the memory. The first switching circuit is disposed between the first signal input pin and the digital serial bus controlling circuit so that the first switching circuit controls the electrical connection between the first signal input pin and the digital serial bus controlling circuit based on a signal. The signal is applied to the first switching circuit through the control input pin. The second switching circuit is disposed between the second signal input pin and the digital serial bus controlling circuit so that the second switching circuit controls the electrical connection between the second signal input pin and the digital serial bus controlling circuit based on the signal. The signal is applied to the second switching circuit through the control input pin.

Therefore, whether the connector has single NC pin or does not have any NC pin, a digital serial bus may be electrically coupled to the connector. In addition, the internal modules are coupled to one another through the digital serial bus even though the number of the pins of the connector is minimized. Furthermore, the connector is coupled to the 12C bus.

The present application claims priority from Korean Patent Application No. 2004-80530, filed on Oct. 8, 2004, the disclosure of which is hereby incorporated herein by reference in its entirety.

### BRIEF DESCRIPTION OF THE DRAWINGS

The above and other advantages of the present invention will become more apparent by describing in detail exemplary embodiments thereof with reference to the accompanying drawings, in which:

FIG. 1 is a block diagram showing thirty pins of a connector of an LCD apparatus standardized by PSWG;

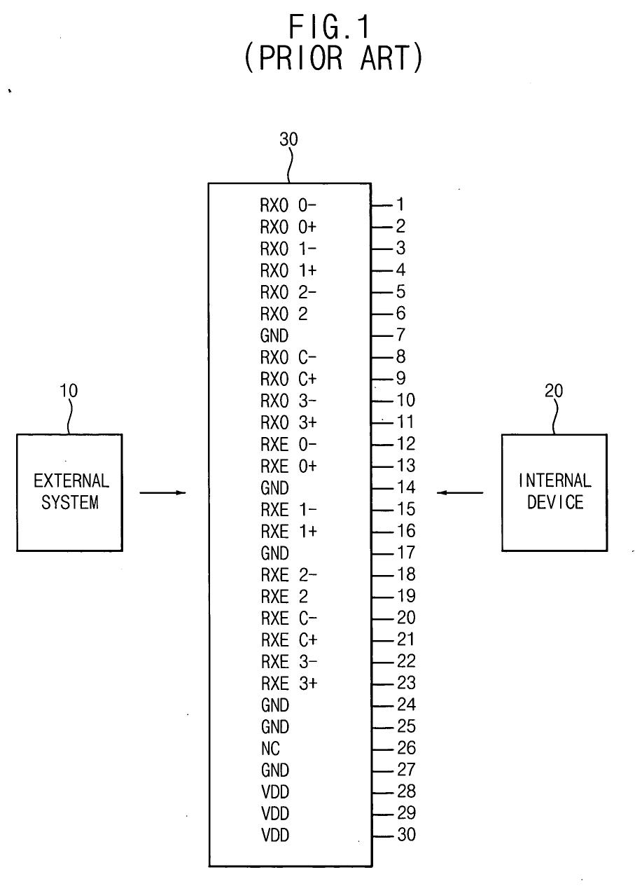

FIG. 2 is a block diagram showing a control device for a display apparatus in accordance with an exemplary embodiment of the present invention;

FIG. 3 is a block diagram for describing an operation of the control device of FIG. 2;

FIG. 4 is a block diagram for describing another operation of the control device of FIG. 2;

FIG. 5 is a block diagram showing a control device for a display apparatus in accordance with another exemplary embodiment of the present invention;

FIG. 6 is a block diagram for describing an operation of the control device of FIG. 5;

FIG. 7 is a block diagram for describing another operation of the control device of FIG. 5;

FIG. 8 is a block diagram showing a control device for a display apparatus in accordance with another exemplary embodiment of the present invention;

FIG. 9 is a block diagram showing a control device for a display apparatus in accordance with another exemplary embodiment of the present invention;

FIG. 10 is a block diagram showing an integrated circuit (IC) chip in accordance with another exemplary embodiment of the present invention; and

FIG. 11 is a block diagram showing an IC chip in accordance with another exemplary embodiment of the present invention.

### DESCRIPTION OF THE EXEMPLARY EMBODIMENTS

It should be understood that the exemplary embodiments of the present invention described below may be modified in many different ways without departing from the inventive principles disclosed herein, and the scope of the present invention is therefore not limited to these particular following embodiments. Rather, these embodiments are provided so that this disclosure will be through and complete, and will fully convey the concept of the invention to those skilled in the art by way of example and not of limitation.

Hereinafter, the present invention will be described in detail with reference to the accompanying drawings.

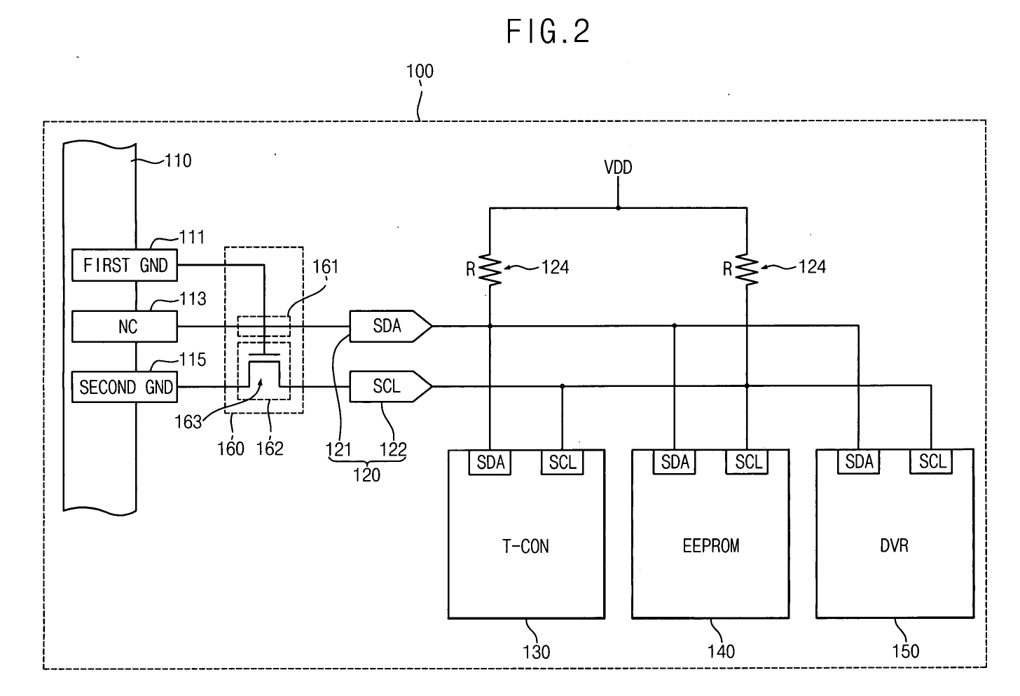

FIG. 2 is a block diagram showing a control device 100 for a display apparatus in accordance with an exemplary embodiment of the present invention. Connector 110 has one NC pin 113 and two GND pins 111 and 115.

The control device 100 for the display apparatus applies control signals to a plurality of driving modules, for example a gate driver for driving gate lines of a liquid crystal display (LCD) panel and a data driver for driving data lines of the LCD panel so as to drive the liquid crystal display (LCD) panel. The control device 100 also stores operation data for operating the display apparatus.

Referring to FIG. 2, the control device 100 for the display apparatus includes modules 130, 140 and 150. The modules 130, 140 and 150 include a timing controller (T-CON) 130, memory units 140 and 150. The memory units 140 and 150 include, for example an electrically erasable programmable read-only memory (EEPROM) 140 and a digital variable register (DVR) 150. The modules 130, 140 and 150 are coupled to one another through an inter IC bus 120. The T-CON 130 functions as a bus master.

The inter IC bus 120 includes a first line and a second line. Resistors 124 set a base voltage level on the first and second lines. In the present exemplary embodiment, the first line is a serial data (SDA) line 121 for transmitting data, and the second line is a serial clock (SCL) line 122 for transmitting a clock signal. Alternatively, the first line may be the serial clock (SCL) line for transmitting the clock signal, and the second line may be the serial data (SDA) line for transmitting the data.

The first GND pin 111, the second GND pin 115 and the NC pin 113 are electrically coupled to the inter IC bus 120 through an interface device 160.

The interface device 160 includes an NC pin connecting circuit 161 and a GND pin connecting circuit 162. The NC pin 113 of the connector 110 is electrically coupled to the SDA line 121 of the inter IC bus 120 through the NC pin connecting circuit 161 that includes a connecting line that connects the NC pin 113 to the SDA line 121.

When a signal having a non-active level is applied to the GND pin connecting circuit 162 through the first GND pin 111, the second GND pin 115 is disconnected from the SCL line 122 of the inter IC bus 120. When a signal having an active level is applied to the GND pin connecting circuit 162 through the first GND pin 111, the second GND pin 115 is electrically connected to the SCL line 122 of the inter IC bus 120.

The GND pin connecting circuit 162 includes a metal oxide semiconductor (MOS) transistor 163 disposed between the second GND pin 115 and the SCL line 122. A gate electrode of the MOS transistor 163 is electrically coupled to the first GND pin 111.

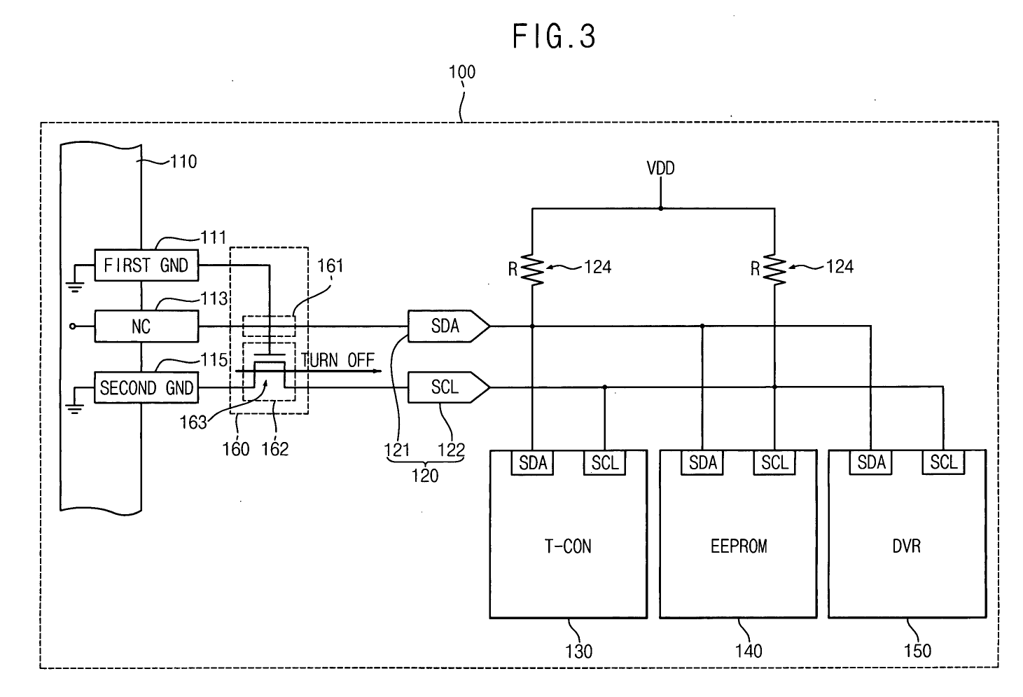

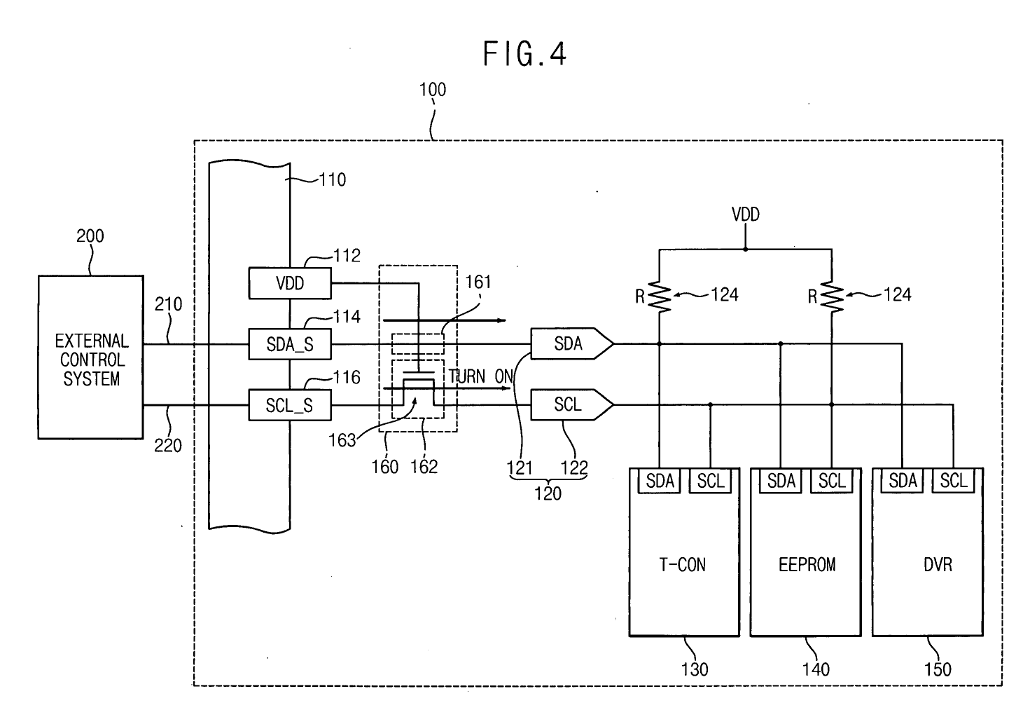

FIG. 3 is a block diagram for describing an operation of the control device 100 in FIG. 2, wherein the control device 100 has no connection with an external control system. FIG. 4 is a block diagram for describing an operation of the control device 100 in FIG. 2, wherein the control device 100 has an electrical connection with an external control system 200.

Referring to FIG. 3, the interface device 160 of the control device 100 is not connected to an external control system. In this embodiment, the first GND pin 111 and the second GND pin 115 are electrically connected to ground potential, and the NC pin 113 has no electrical connection with an external control system. In other words, the first and second GND pins 111 and 115 are electrically connected to ground potential so that the MOS transistor 163 is turned off, and the second GND pin 115 is electrically isolated from the SCL line 122. In addition, although the SDA line 121 is electrically coupled to the NC pin 113, the NC pin 113 is disconnected from the external control system so that the SDA line 121 is also electrically isolated from the external control system.

Therefore, the SDA line 121 and the SCL line 121 and 122 are electrically isolated from the external control system so that the modules 130, 140 and 150 are independently operated using the T-CON 130 as the bus master.

Referring to FIG. 4, the external control system 200 is electrically connected to the modules 130, 140 and 150 through the connector 110. The NC pin 113 and the second GND pin 115 (referring to FIG. 3) are electrically coupled to an external SDA line 210 and an external SCL line 220, respectively, of an external inter IC bus of the external control system 200, and a driving voltage (VDD) is applied to the first GND pin 111 (referring to FIG. 3). Therefore, the first GND pin 111, the NC pin 113 and the second GND pin 115 (referring to FIG. 3) function as a VDD pin 112, an SDA signal (SDA_S) pin 114 and an SCL signal (SCL_S) pin 116, respectively. The external control system 200 may be electrically connected to the modules 130, 140 and 150 to change operation data (or setting variables) that are used for operating the display apparatus, or to test the control device 100 for the display apparatus.

The VDD is applied to the gate electrode of the MOS transistor 163 through the VDD pin 112 so that the MOS transistor 163 is turned on. When the MOS transistor 163 is turned on, the SCL_S pin 116 and the SDA_S pin 114 are electrically coupled to the SCL line 122 and the SDA line 121 of the inter IC bus 120, respectively. The NC pin connecting circuit 161 is disposed between the SDA_S pin 114 and the SDA line 121 of the inter IC bus 120.

Therefore, the inter IC bus 120 of the control device 100 for the display apparatus is electrically coupled to the external control system 200.

According to the present exemplary embodiment, the control device 100 for the display apparatus, which has the inter IC bus 120, may be coupled to the external control system 200, although the SCL line 122 of the inter IC bus 120 is electrically coupled to the GND pin 115 of the connector 110.

In the present exemplary embodiment, the connector 110 includes single NC pin 113. Alternatively, the connector 100 may not have the NC pin and two GND pins, and the connector 100 may instead have three GND pins.

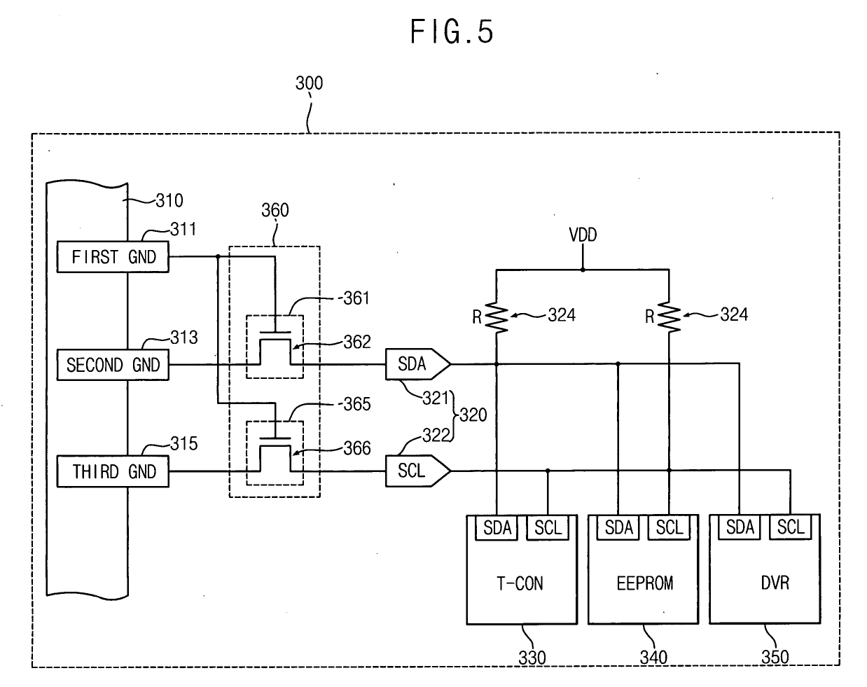

FIG. 5 is a block diagram showing a control device 300 for a display apparatus in accordance with another exemplary embodiment of the present invention. The control device 300 for the display apparatus of FIG. 5 is same as in FIG. 2 except for an interface device 360 and the three GND pins. Thus, the same reference numerals will be used to refer to the same or like parts as those described in FIG. 2 and any further explanation will be omitted.

The control device 300 for the display apparatus applies control signals to a plurality of driving modules so as to drive the liquid crystal display (LCD) panel, and the control device 300 for the display apparatus stores operation data that are used for operating the display apparatus.

Referring to FIG. 5, the control device 300 for the display apparatus includes modules 330, 340 and 350. The modules 330, 340 and 350 include a timing controller (T-CON) 330, and memory units 340 and 350. The memory units 340 and 350 include, for example, an electrically erasable programmable read-only memory (EEPROM) 340 and a digital variable register (DVR) 350. The modules 330, 340 and 350 are coupled to one another through an inter IC bus 320.

The inter IC bus 320 includes a first line and a second line. Resistors 324 set a base voltage level on first and second lines. In the present exemplary embodiment, the first line is a serial data (SDA) line 321 for transmitting data, and the second line is a serial clock (SCL) line 322 for transmitting a clock signal. Alternatively, the first line may be the SCL line 322 for transmitting the clock signal, and the second line may be the SDA line 321 for transmitting the data signal.

A first GND pin 311, a second GND pin 313, and a third GND pin 315 are electrically coupled to the inter IC bus 320 through the interface device 360.

The interface device 360 includes a first GND pin connecting circuit 361 and a second GND pin connecting circuit 365. When a signal having a non-active level is applied to the first GND pin connecting circuit 361 through the first GND pin 311, the second GND pin 313 is electrically isolated from the SDA line 321 of the inter IC bus 320. However, when the signal having an active level is applied to the first GND pin connecting circuit 361 through the first GND pin 311, the second GND pin 313 is electrically coupled to the SDA line 321 of the inter IC bus 320. When the signal having the non-active level is applied to the second GND pin connecting circuit 365 through the first GND pin 311, the third GND pin 315 is electrically isolated from the SCL line 322 of the inter IC bus 320. However, when the signal having the active level is applied to the second GND pin connecting circuit 365 through the first GND pin 311, the third GND pin 315 is electrically coupled to the SCL line 322 of the inter IC bus 320.

The first GND pin connecting circuit 361 includes a first MOS transistor 362. The first MOS transistor 362 is disposed between the second GND pin 313 and the SDA line 321, and includes a gate electrode that is electrically coupled to the first GND pin 311. The second GND pin connecting circuit 365 includes a second MOS transistor 366. The second MOS transistor 366 is disposed between the third GND pin 315 and the SCL line 322, and includes a gate electrode that is electrically coupled to the first GND pin 311.

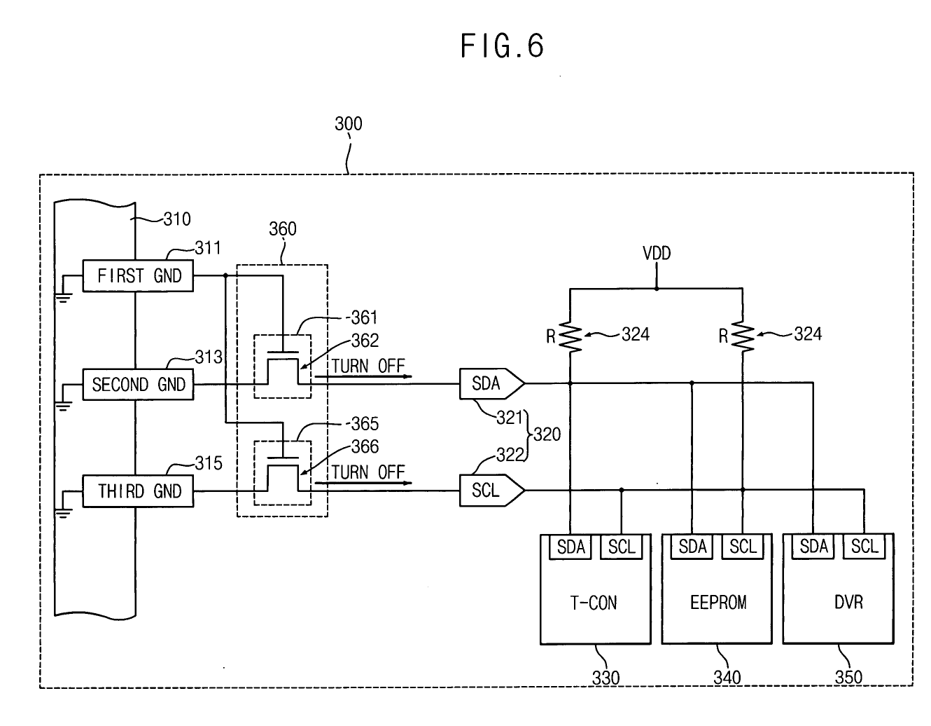

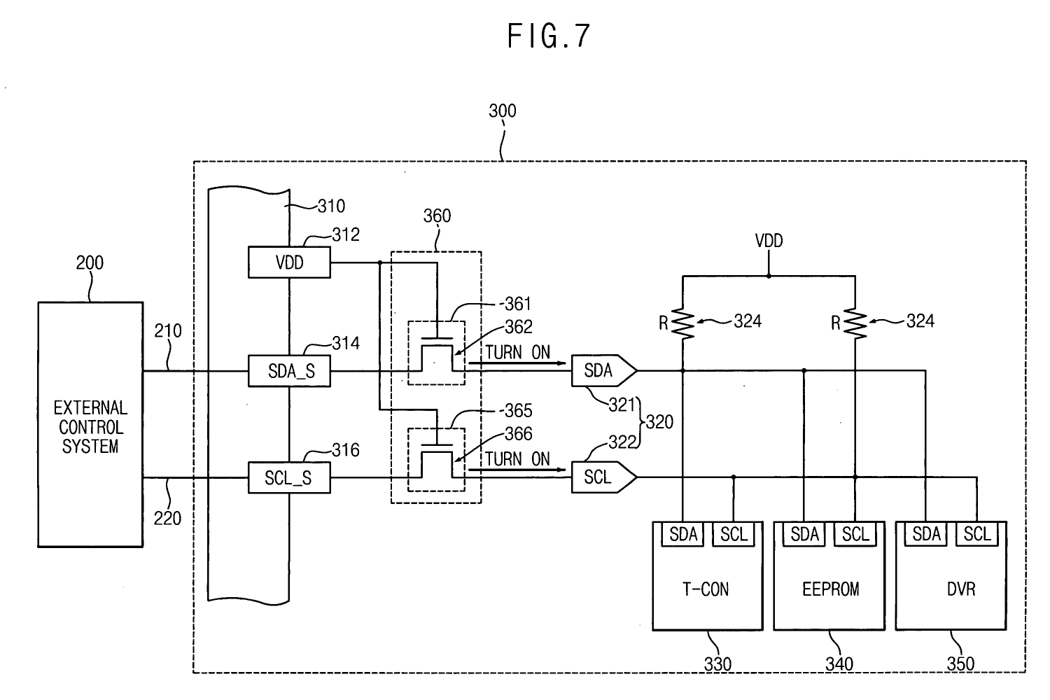

FIG. 6 is a block diagram for describing operation of the control device 300, wherein the interface device 360 is not coupled to an external control system. FIG. 7 is a block diagram for describing an operation of the control device 300, wherein the interface device 360 is coupled to the external control system 200.

Referring to FIG. 6, when the interface device 360 has no electrical connection to an external control system, the first, second, and third GND pins 311, 313 and 315 are electrically connected to ground potential. Since the first and second GND pins 311 and 313 are electrically coupled to ground potential, the first MOS transistor 362 is turned off, and the second GND pin 313 is electrically isolated from the SDA line 321. In addition, since the first and third GND pins 311 and 315 are electrically coupled to ground potential, the second MOS transistor 366 is turned off, and the third GND pin 315 is electrically isolated from the SCL line 322.

Therefore, the SDA line 321 and the SCL line 322 are electrically isolated from the second and third GND pins 313 and 315, respectively, so that the modules 330, 340 and 350 are independently operated using the T-CON 330 as the bus master.

Referring to FIG. 7, when the external control system 200 is electrically coupled to the modules 330, 340 and 350 of the control device 300 for the display apparatus, the second GND pin 313 and the third GND pin 315 (referring to FIG. 6) are electrically coupled to an external SDA line 210 and an external SCL line 220, respectively, of an external inter IC bus of the external control system 200 and a driving voltage (VDD) is applied to the first GND pin 311 (referring to FIG. 6). In this embodiment, the driving voltage VDD has a positive voltage. When connected as described above, the first, second, and third GND pins 311, 313 and 315 serve as a VDD pin 312, an SDA signal (SDA_S) pin 314, and an SCL signal (SCL_S) pin 316, respectively.

The external control system 200 may be coupled to the modules 330, 340 and 350 so as to change the operation data that are used for operating the display apparatus, or to test the control device 300 for the display apparatus.

The VDD is applied to the gate electrode of the first MOS transistor 362 and gate electrode of the second MOS transistor 366 through the VDD pin 312 so that the first and second MOS transistors 362 and 366 are turned on. When the first and second MOS transistors 362 and 366 are turned on, the SDA_S pin 314 and the SCL_S pin 316 are electrically coupled to the SDA line 321 and the SCL line 322, respectively.

Therefore, the inter IC bus 320 of the control device 300 for the display apparatus is electrically coupled to the external inter IC bus so that the control device 300 for the display apparatus is electrically coupled to the external control system 200.

According to the present exemplary embodiment, although the connector 310 does not have the NC pin, the control device 300 for the display apparatus, which has the inter IC bus 320, may be coupled to the external control system 200 and the inter IC bus 320 may be independently activated (or operated).

Alternatively, the connector may be electrically coupled to a module having a write protection (WP) pin or a bus release (BRP) pin.

A writable module may include the WP pin or the BRP pin. The writable module may be an electrically erasable programmable read-only memory (EEPROM) or a digital variable register (DVR). The WP pin is classified as either a WPp pin or a WPn pin. When the signal having the active level is applied to the WPp pin, data may not be written in the writable module. When the signal having the non-active level is applied to the WPn pin, data may not be written in the writable module. When the signal having the active level is applied to the BRP pin, the inter IC bus may not be accessed by the writable module. When the signal having the non-active level is applied to the BRP pin, the inter IC bus may be accessed by the writable module.

When the inter IC bus is independently activated (or operated) in the control device, the prohibition of the data writing operation is required to maintain the data stored in the writable module. Therefore, to prohibit the data writing operation when the writable module has the WPp pin, the signal having the active level is applied to the WPp pin. To prohibit the data writing operation when the writable module has the WPn pin, the signal having the non-active level is applied to the WPn pin. However, when the inter IC bus is coupled to the external control system, the prohibition of the data writing operation needs to be cancelled. Therefore, to allow the data writing operation when the writable module has the WPp pin, the signal having the non-active level is applied to the WPp pin. To allow the data writing operation when the writable module has the WPn pin, the signal having the active level is applied to the WPn pin.

When the writable module includes the BRP pin and the inter IC bus is independently operated, the signal having the non-active level is applied to the BRP pin so that the inter IC bus is accessed by the writable module. However, when the inter IC bus is coupled to the external control system, the signal having the active level is applied to the BRP pin.

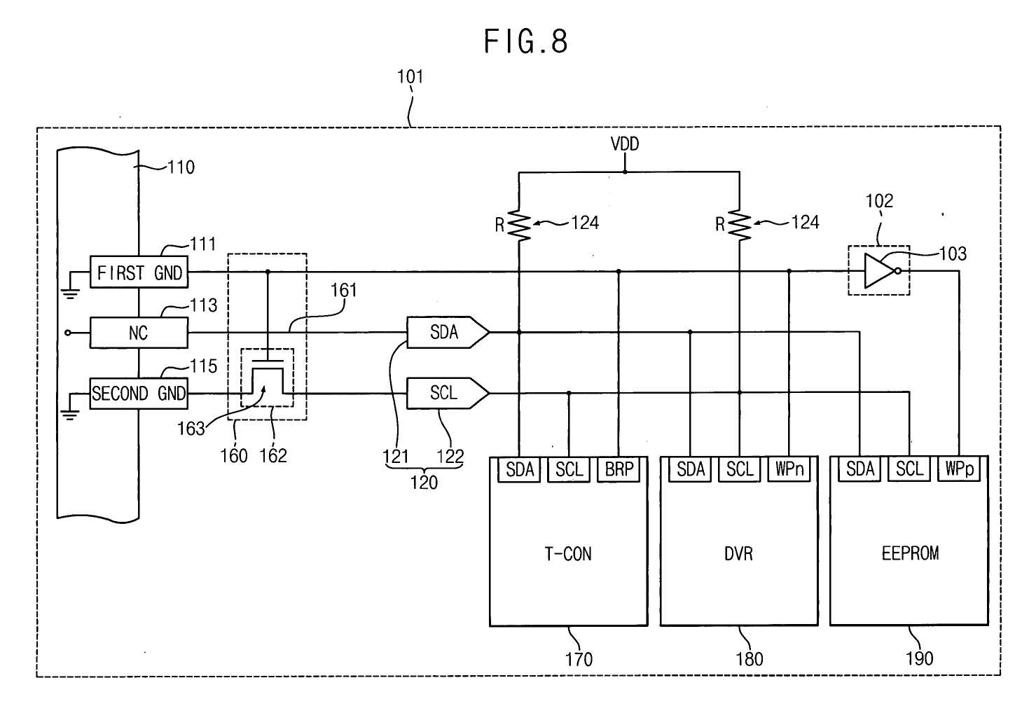

FIG. 8 is a block diagram showing a control device 101 for a display apparatus in accordance with another exemplary embodiment of the present invention. The control device for the display apparatus of FIG. 8 is same as the control device in FIG. 2 except, for example, the WP pin and the BRP pin. Thus, the same reference numerals will be used to refer to the same or like parts as those described in FIG. 2 and any further explanation will be omitted.

Referring to FIG. 8, an EEPROM 190, a DVR 180 and a T-CON 170 have the WPp pin, the WPn pin and the BRP pin, respectively. The EEPROM 190, the DVR 180 and the T-CON 170 are coupled to the inter IC bus 120. When the EEPROM 190, the DVR 180 and the T-CON 170 are not electrically coupled to the external control system 200, the EEPROM 190, the DVR 180 and the T-CON 170 are independently operated. When the EEPROM 190, the DVR 180 and the T-CON 170 are independently operated, the signal having the active level, the signal having the non-active level and the signal having the non-active level are applied to the WPp pin of the EEPROM 190, the WPn pin of the DVR 180 and the BRP pin of the T-CON 170, respectively.

The first GND pin 111 is electrically coupled to the WPp pin of the EEPROM 190, the WPn pin of the DVR 180 and the BRP pin of the T-CON 170, and an inverting circuit 102 is disposed between the first GND pin 111 and the WPp pin of the EEPROM 190. In the present exemplary embodiment, the inverting circuit 102 has an inverter 103.

When the inter IC bus 120 of the control device 101 is not electrically coupled to the external control device, the control device 101 is independently operated, and the first GND pin 111 is electrically coupled to ground potential. The signal having the non-active level is applied to the WPn pin so that data may not be written in the DVR 180. In addition, the T-CON 170 functions as master of the inter IC bus 120 to control the inter IC bus 120. Further, the signal having the active level that is generated by inverting the signal applied to the WPn pin is applied to the WPp pin so that data may not be written in the EEPROM 190. Therefore, data stored in the DVR 180 and the EEPROM 190 is not changed so that the T-CON 170 controls the internal device.

When the inter IC bus 120 of the control device 101 is coupled to the external control device, a VDD is applied to the first GND pin 111. The signal having the active level is applied to the WPn pin and the BRP pin. In addition, the signal having the non-active level that is generated by inverting the signal applied to the WPn pin and the BRP pin is applied to the WPp pin. Therefore, data may be written in the EEPROM 190 and the DVR 180, and the T-CON 170 is not electrically coupled to the INTER IC bus 120 so that control data and operation data (or setting data) stored in the EEPROM 190 and the DVR 180 may be changed by the external control system, and the T-CON 170 functions as the master of the inter IC bus 120.

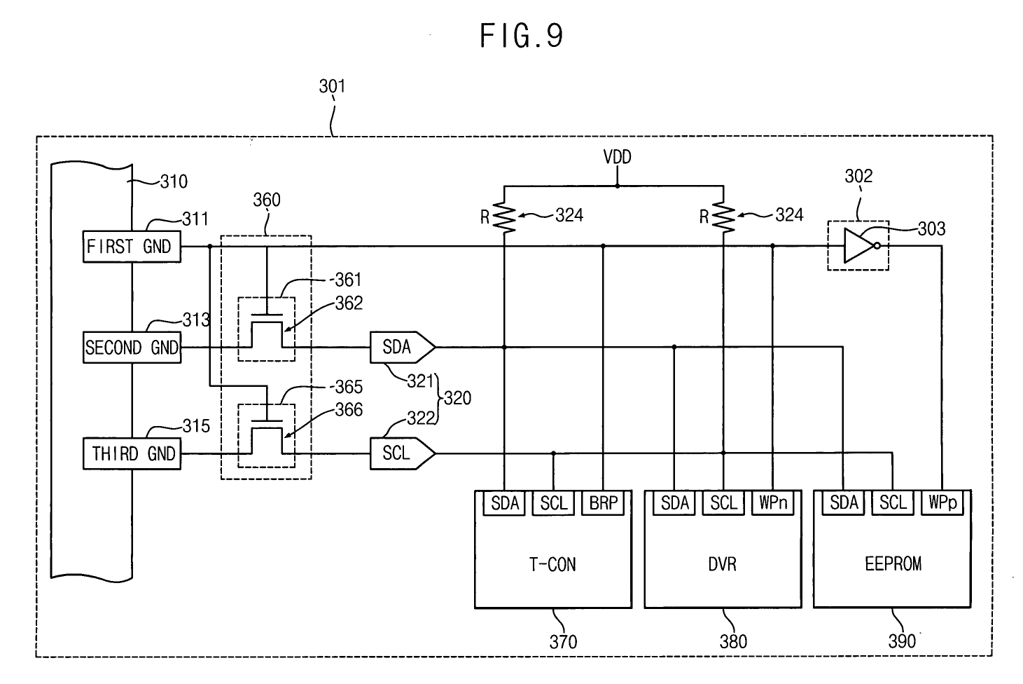

FIG. 9 is a block diagram showing a control device 301 for a display apparatus in accordance with another exemplary embodiment of the present invention. The control device 301 for the display apparatus of FIG. 9 is same as in FIG. 5 except, for example, the WP pin and the BRP pin. Thus, the same reference numerals will be used to refer to the same or like parts as those described in FIG. 5 and any further explanation will be omitted.

Referring to FIG. 9, an EEPROM 390, a DVR 380 and a T-CON 370 have the WPp pin, the WPn pin and the BRP pin, respectively. The EEPROM 390, the DVR 380 and the T-CON 370 are coupled to the inter IC bus 320. When the EEPROM 390, the DVR 380 and the T-CON 370 are not electrically coupled to an external control system, the EEPROM 390, the DVR 380 and the T-CON 370 are independently operated. When the EEPROM 390, the DVR 380 and the T-CON 370 are independently operated, the signal having the active level, the signal having the non-active level and the signal having the non-active level are applied to the WPp pin of the EEPROM 390, the WPn pin of the DVR 380 and the BRP pin of the T-CON 370, respectively.

The first GND pin 311 is electrically coupled to the WPp pin of the EEPROM 390, the WPn pin of the DVR 380 and the BRP pin of the T-CON 370, and an inverting circuit 302 is disposed between the first GND pin 311 and the WPp pin of the EEPROM 390. In the present exemplary embodiment, the inverting circuit 302 has an inverter 303.

When the inter IC bus 320 of the control device 301 is not electrically coupled to the external control device 200, the control device 301 is independently operated, and the first GND pin 311 is electrically connected to ground potential. The signal having the non-active level is applied to the WPn pin so that data may not be written in the DVR 380. In addition, the T-CON 370 functions as master of the inter IC bus 320 to control the inter IC bus 320. Further, the signal having the active level that is generated by inverting the signal applied to the WPn pin is applied to the WPp pin so that data may not be written in the EEPROM 390. Therefore, data stored in the DVR 380 and the EEPROM 390 is not changed so that the T-CON 370 controls the internal device.

When the inter IC bus 320 of the control device 301 is coupled to the external control device 200, a VDD is applied to the first GND pin 311. The signal having the active level is applied to the WPn pin and the BRP pin. In addition, the signal having the non-active level that is generated by inverting the signal applied to the WPn pin and the BRP pin is applied to the WPp pin. Therefore, data may be written in the EEPROM 390 and the DVR 380, and the T-CON 370 is not electrically coupled to the inter IC bus 320 so that control data and setting data stored in the EEPROM 390 and the DVR 380 may be changed by the external control system 200, and the T-CON 370 functions as the master of the inter IC bus 320.

According to the present exemplary embodiment, the control device 301 for the display apparatus, which has the inter IC bus 320, may be coupled to the external control system 200 using the first, second, and third GND pins 311, 313, and 315, respectively. Such control device 301 also may have the inverting circuit 302.

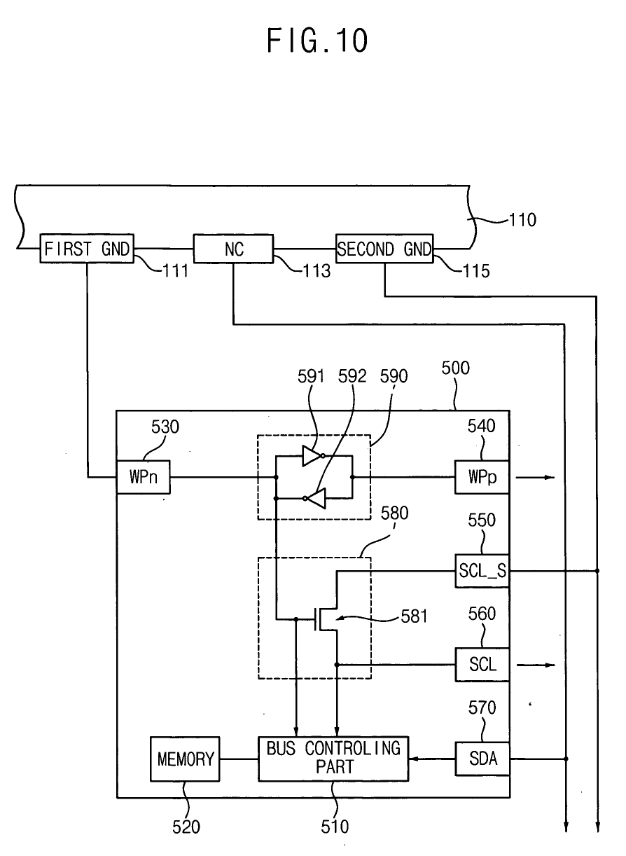

FIG. 10 is a block diagram showing an integrated circuit (IC) chip 500 in accordance with another exemplary embodiment of the present invention. The IC chip 500 includes a plurality of pins, such as a WPn pin 530, a WPp pin 540, an SCL_S pin 550, an SCL pin 560, an SDA pin 570, etc., an inverting circuit 590, a switching circuit 580, an inter IC bus controlling circuit 510 and a memory 520. The switching circuit 580 acts as an interface device. The connector 110 of FIG. 10 is same as in FIG. 2. Thus, the same reference numerals will be used to refer to the same or like parts as those described in FIG. 2 and any further explanation will be omitted. The connector 110 includes the first GND pin 111, the NC pin 113 and the second GND pin 115.

In the present exemplary embodiment, a first signal and a second signal are applied to an SDA line that is electrically coupled to the SDA pin 570 and an SCL line that is electrically coupled to the SCL_S pin 550, respectively. Alternatively, the second and first signals may be applied to the SDA line and the SCL line, respectively.

The WPn 530 is electrically coupled to the first GND pin 111 of the connector 110 to receive a switching signal, which is either an active level or a non-active level. The SCL_S pin 550 is electrically coupled to the second GND pin 115 of the connector 110 to receive the second signal that is a serial clock (SCL) signal. The SDA pin 570 is electrically coupled to the NC pin 113 of the connector 110 to receive the first signal that is serial data (SDA).

A write protection signal, which is generated by inverting the switching signal that is applied to the WPn 530, is applied to the WPp pin 540. The second signal that is the SCL is applied to the SCL_S pin 550. The WPp pin 540 and the SCL pin 560 may be electrically coupled to a WPp pin (not shown) of another IC chip (not shown) and an SCL pin (not shown) of the another IC chip (not shown), respectively.

The inverting circuit 590 includes an inverter 591 that outputs the write protection signal to the WPp 540 pin based on the switching signal applied to the WPn 530. In the present exemplary embodiment, an auxiliary inverter 592 is electrically coupled in parallel with the inverter 591. When the WPn 530 receives the switching signal the WPp receives the write protection signal. The auxiliary inverter 592 is coupled in a reverse direction to the inverter 591.

The switching circuit 580 is disposed between the SCL_S pin 550 and the SCL pin 560. When the switching signal having the non-active level is applied to the WPn 530, the SCL_S pin 550 is electrically isolated from the SCL pin 560. However, when the switching signal having the active level is applied to the WPn 530, the SCL_S pin 550 is electrically coupled to the SCL pin 560. In the present exemplary embodiment, the switching circuit 580 includes a MOS transistor 581 that is disposed between the SCL_S pin 550 and the SCL pin 560. A gate electrode of the MOS transistor 581 is electrically coupled to the WPn 530.

The inter IC bus controlling circuit 510 is electrically coupled to the WPn pin 530, the SCL pin 560 and the SDA pin 570. When the switching signal having the non-active level is applied to the inter IC bus controlling circuit 510 through the WPn pin 530, data may not be written in the memory 520. However, when the switching signal having the active level is applied to the inter IC bus controlling circuit 510 through the WPn pin 530, the data may be written in the memory 520. The SCL and the SDA are applied to the memory 520 through the inter IC bus controlling circuit 510.

According to the present exemplary embodiment, the display apparatus has a switching circuit 580, which acts as the interface device. The IC chip 500 is electrically coupled to the first GND pin, the second GND pin and the NC pin so that the connector 110 is coupled to the inter IC bus. In addition, the writing operation of data may be controlled by the inter IC bus controlling circuit. Furthermore, the IC chip 500 may be electrically coupled to the another IC chip (not shown).

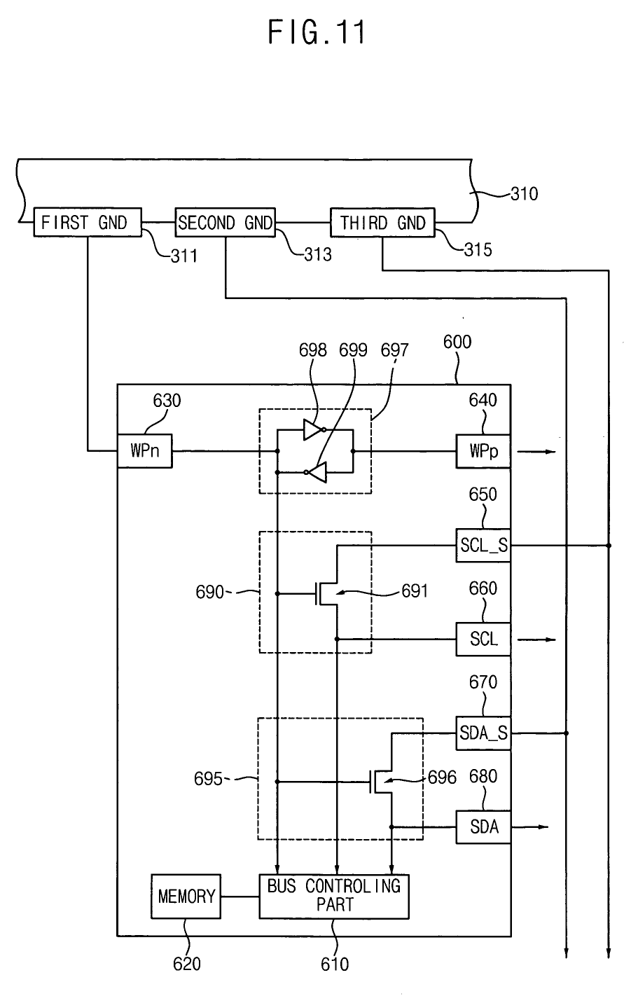

FIG. 11 is a block diagram showing an IC chip in accordance with another exemplary embodiment of the present invention. An IC chip 600 includes a plurality of pins, such as a WPn pin 630, a WPp pin 640, an SCL_S pin 650, an SCL pin 660, an SDA_S pin 670, SDA pin 680, etc., an inverting circuit 697, an SCL switching circuit 690, an SDA switching circuit 695, an inter IC bus controlling circuit 610 and a memory 620. The SCL switching circuit 690 and the SDA switching circuit 695 combine to act as an interface device. The connector 310 of FIG. 11 is same as in FIG. 5. Thus, the same reference numerals will be used to refer to the same or like parts as those described in FIG. 5 and any further explanation will be omitted. The connector 310 includes the first GND pin 311, the second GND pin 313 and the third GND pin 315.

The WPn 630 is electrically coupled to the first GND pin 311 of the connector 310 to receive a switching signal, which may be either an active level or a non-active level. The SCL_S pin 650 is electrically coupled to the third GND pin 315 of the connector 310 to receive the serial clock (SCL) signal. The SDA_S pin 670 is electrically coupled to the second GND pin 313 of the connector 310 to receive serial data (SDA).

The WPp pin 640, the SCL pin 660 and the SDA pin 680 may be electrically coupled to a WPp pin (not shown) of another IC chip (not shown), an SCL_S pin (not shown) of the another IC chip (not shown) and an SDA_S pin (not shown) of the another IC chip (not shown), respectively. A write protection signal, which is generated by inverting the switching signal applied to the WPn 630, is applied to the WPp pin 640.

The inverting circuit 697 includes an inverter 698 that outputs the write protection signal to the WPp 640 pin based on the switching signal applied to the WPn 630. In the present exemplary embodiment, an auxiliary inverter 699 is electrically coupled in parallel with the inverter 698. When the WPn pin 630 receives the switching signal, the WPp pin 640 receives the write protection signal from the inverter 698. The WPp pin 640 is electrically coupled to the WPn pin (not shown) of the another IC chip (not shown). The auxiliary inverter 699 is coupled in a reverse direction to the inverter 698.

The SCL switching circuit 690 is disposed between the SCL_S pin 650 and the SCL pin 660. When the switching signal having the non-active level is applied to the WPn 630, the SCL_S pin 650 is electrically isolated from the SCL pin 660. However, when the switching signal having the active level is applied to the WPn 630, the SCL_S pin 650 is electrically coupled to the SCL pin 660. In the present exemplary embodiment, the SCL switching circuit 690 includes an SCL switching MOS transistor 691 that is disposed between the SCL_S pin 650 and the SCL pin 660. A gate electrode of the SCL switching MOS transistor 691 is electrically coupled to the WPn 630.

The SDA switching circuit 695 is disposed between the SDA_S pin 670 and the SDA pin 680. When the switching signal having the non-active level is applied to the WPn 630, the SDA_S pin 670 is electrically isolated from the SDA pin 680. However, when the switching signal having the active level is applied to the WPn 630, the SDA_S pin 670 is electrically coupled to the SDA pin 680. In the present exemplary embodiment, the SDA switching circuit 695 includes an SDA switching MOS transistor 696 that is disposed between the SDA_S pin 670 and the SDA pin 680. A gate electrode of the SDA switching MOS transistor 696 is electrically coupled to the WPn 630.

The inter IC bus controlling circuit 610 is electrically coupled to the WPn pin 630, the SCL pin 660 and the SDA pin 680. When the switching signal having the non-active level is applied to the INTER IC bus controlling circuit 610 through the WPn pin 630, data may not be written in the memory 620. However, when the switching signal having the active level is applied to the INTER IC bus controlling circuit 610 through the WPn pin 630, data may be written in the memory 620. The SCL and the SPA are applied to the memory 620 through the INTER IC bus controlling circuit 610.

According to the present exemplary embodiment, the IC chip 600 includes the SCL and SDA switching circuits 690 and 695 that act as an interface device. The IC chip 600 is electrically coupled to the first GND pin, the second GND pin and the third GND pin so that the connector 310 is coupled to the inter IC bus. In addition, the writing operation of data may be controlled by the inter IC bus controlling circuit. Furthermore, the IC chip 600 may be electrically coupled to the another IC chip (not shown).

According to the present invention, whether the connector has single NC pin or the connector does not have any NC pin, the control device for the display apparatus, which has the digital serial bus, may be coupled to the external control system.

In addition, the control device for the display apparatus includes the interface device so that the modules are coupled to one another through the digital serial bus, regardless of the number and configuration of pins of the PSWG standardized connector. The control device may also include the inverting circuit for use with the modules having the WP pin or the BRP pin.

Further, the IC chip includes the MOS transistors that act as an interface device and the inverting circuit so that the IC chip is coupled to the GND pins of the connector.

This invention has been described with reference to the exemplary embodiments. It is evident, however, that many alternative modifications and variations will be apparent to those having skill in the art in light of the foregoing description. Accordingly, the present invention embraces all such alternative modifications and variations as fall within the spirit and scope of the appended claims.

What is claimed is:

1. An interface device between a connector and a digital serial bus, the interface device comprising:
a non-connection pin connecting circuit that electrically connects a non-connection pin of the connector to a first line of the digital serial bus; and
a ground pin connecting circuit that receives a control signal applied to the ground pin connecting circuit through a first ground pin of the connector, the ground pin connecting circuit controls electrical connection between a second ground pin of the connector and a second line of the digital serial bus in response to the control signal.

2. The interface device of claim 1, wherein the ground pin connecting circuit provides electrical connection between the second ground pin of the connector and the second line of the digital serial bus in response to the control signal having an active level.

3. The interface device of claim 1, wherein the ground pin connecting circuit provides electrical disconnection between the second ground pin of the connector and the second line of the digital serial bus in response to the control signal having a non-active level.

4. The interface device of claim 1, wherein the first line comprises a serial data line that transmits serial data, and the second line comprises a serial clock line that transmits a serial clock signal.

5. The interface device of claim 1, wherein the first line comprises a serial clock line that transmits a serial clock signal, and the second line comprises a serial data line that transmits serial data.

6. The interface device of claim 1, wherein the ground pin connecting circuit comprises a metal oxide semiconductor transistor coupled between the second ground pin and the second line, and a gate electrode of the metal oxide semiconductor transistor is electrically coupled to the first ground pin.

7. A control device for a display apparatus comprising:
a connector including a first ground pin, a non-connection pin, and a second ground pin;
a digital serial bus including a first line and a second line;
a plurality of modules electrically coupled to the first and second lines of the digital serial bus, the modules generating a control signal for controlling the display apparatus and setting operation data that are used for operating the display apparatus; and
an interface device between the connector and the digital serial bus including:
a non-connection pin connecting circuit that electrically connects the non-connection pin to the first line; and
a ground pin connecting circuit that receives a signal applied to the ground pin connecting circuit through a first ground pin of the connector, the ground pin connecting circuit controls electrical connection between the second ground pin of the connector and the second line of the digital serial bus in response to the signal from the first ground pin.

8. The control device of claim 7, wherein the digital serial bus comprises an inter integrated circuit bus.

9. The control device of claim 7, wherein the first line comprises a serial data line that transmits serial data, and the second line comprises a serial clock line that transmits a serial clock signal.

10. The control device for the display apparatus of claim 7, wherein the first line comprises a serial clock line that transmits a serial clock signal, and the second line comprises a serial data line that transmits serial data.

11. The control device for the display apparatus of claim 7, wherein the ground pin connecting circuit comprises a metal oxide semiconductor transistor coupled between the second ground pin and the second line, and a gate electrode of the metal oxide semiconductor transistor is electrically coupled to the first ground pin.

12. The control device for the display apparatus of claim 7, wherein the modules comprises:
a timing controller that generates the control signal, the timing controller being a bus master of the digital serial bus; and
a memory unit that stores the operation data.

13. The control device for the display apparatus of claim 12, wherein the memory unit comprises an electrically erasable programmable read-only memory.

14. The control device for the display apparatus of claim 12, wherein the memory unit comprises a digital variable register.

15. The control device for the display apparatus of claim 12, wherein the memory unit comprises a write protection pin configured to protect the operation data, and the write protection pin is electrically coupled to the first ground pin.

16. The control device for the display apparatus of claim 15, wherein the write protection pin comprises a positive write protection pin, and data are not written in the memory unit when the signal having an active level is applied to the positive write protection pin.

17. The control device for the display apparatus of claim 16, further comprising an inverting circuit electrically coupled to the positive write protection pin to invert the signal applied to the positive write protection pin from the first ground pin.

18. The control device for the display apparatus of claim 17, wherein the inverting circuit comprises an inverter.

19. The control device for the display apparatus of claim 15, wherein the write protection pin comprises a negative write protection pin, and data are not written in the memory unit when the signal having a non-active level is applied to the negative write protection pin.

20. The control device for the display apparatus of claim 7, wherein the control device is coupled to an external control system, a driving voltage is applied to the first ground pin, a first external signal is applied to the non-connection pin through a first line of the external control system, and a second external signal is applied to the second ground pin through a second line of the external control system.

21. An interface device between a connector and a digital serial bus comprising:
a first ground pin connecting circuit that receives a signal applied to the first ground pin connecting circuit through a first ground pin of the connector, the first ground pin connecting circuit controls electrical connection between a second ground pin of the connector and a first line of the digital serial bus; and
a second ground pin connecting circuit that receives the signal applied to the second ground pin connecting circuit through the first ground pin of the connector, the second ground pin connecting circuit controls electrical connection between a third ground pin of the connector and a second line of the digital serial bus.

22. The interface device of claim 21, wherein the first and second ground pin connecting circuits provide electrical connection between the second and third ground pins of the connector and the first and second lines of the digital serial bus, respectively, in response to the signal having an active level.

23. The interface device of claim 21, wherein the first and second ground pin connecting circuits provide electrical disconnection between the second and third ground pins of the connector and the first and second lines of the digital serial bus, respectively, in response to the signal having a non-active level.

24. The interface device of claim 21, wherein the digital serial bus comprises an inter integrated circuit bus.

25. The interface device of claim 21, wherein the first line comprises a serial data line that transmits serial data, and the second line comprises a serial clock line that transmits a serial clock signal.

26. The interface device of claim 21, wherein the first line comprises a serial clock line that transmits a serial clock signal, and the second line comprises a serial data line that transmits serial data.

27. The interface device of claim 21, wherein the first ground pin connecting circuit comprises a first metal oxide semiconductor transistor coupled between the second ground pin and the first line, and a gate electrode of the first metal oxide semiconductor transistor is electrically coupled to the first ground pin.

28. The interface device of claim 21, wherein the second ground pin connecting circuit comprises a second metal oxide semiconductor transistor coupled between the third ground pin and the second line, and a gate electrode of the second metal oxide semiconductor transistor is electrically coupled to the first ground pin.

29. A control device for a display apparatus comprising:
a connector including a first ground pin, a second ground pin, and a third ground pin;
a digital serial bus including a first line and a second line;
a plurality of modules electrically coupled to the first and second lines of the digital serial bus, the modules generating a control signal and setting operation data that are used for operating the display apparatus; and
an interface device between the connector and the digital serial bus including:
a first ground pin connecting circuit that receives a signal applied to the first ground pin connecting circuit through a first ground pin of the connector, the first ground pin connecting circuit controls electrical connection between a second ground pin of the connector and a first line of the digital serial bus; and
a second ground pin connecting circuit that receives the signal applied to the second ground pin connecting circuit through the first ground pin of the connector, the second ground pin connecting circuit controls electrical connection between a third ground pin of the connector and a second line of the digital serial bus.

30. The control device of claim 29, wherein the first and second ground pin connecting circuits control electrical connection between the second and third ground pins of the connector and the first and second lines of the digital serial bus, respectively, in response to the signal provided through the first ground pin.

31. The control device for the display apparatus of claim 29, wherein the digital serial bus comprises an inter integrated circuit bus.

32. The control device for the display apparatus of claim 29, wherein the first line comprises a serial data line that transmits serial data, and the second line comprises a serial clock line that transmits a serial clock signal.

33. The control device for the display apparatus of claim 29, wherein the first line comprises a serial clock line that transmits a serial clock signal, and the second line comprises a serial data line that transmits serial data.

34. The control device for the display apparatus of claim 29, wherein the first ground pin connecting circuit comprises a first metal oxide semiconductor transistor coupled between the second ground pin and the first line, and a gate electrode of the first metal oxide semiconductor transistor is electrically coupled to the first ground pin.

35. The control device for the display apparatus of claim 29, wherein the second ground pin connecting circuit comprises a second metal oxide semiconductor transistor coupled between the third ground pin and the second line, and a gate electrode of the second metal oxide semiconductor transistor is electrically coupled to the first ground pin.

36. The control device for the display apparatus of claim 30, wherein the modules comprise:
a timing controller that generates the control signal, the timing controller being a bus master of the digital serial bus; and
a memory unit that stores the operation data.

37. The control device for the display apparatus of claim 36, wherein the memory unit comprises an electrically erasable programmable read-only memory.

38. The control device for the display apparatus of claim 36, wherein the memory unit comprises a digital variable register.

39. The control device for the display apparatus of claim 36, wherein the memory unit comprises a write protection pin configured to protect the operation data, and the write protection pin is electrically coupled to the first ground pin.

40. The control device for the display apparatus of claim 39, wherein the write protection pin comprises a positive write protection pin, and data are not written in the memory unit when the signal having an active level is applied to the positive write protection pin.

41. The control device for the display apparatus of claim 40, further comprising an inverting circuit electrically coupled to the positive write protection pin to invert the signal applied to the positive write protection pin from the first ground pin.

42. The control device for the display apparatus of claim 41, wherein the inverting circuit comprises an inverter.

43. The control device for the display apparatus of claim 39, wherein the write protection pin comprises a negative write protection pin, and data are not written in the memory unit when the signal having a non-active level is applied to the negative write protection pin.

44. The control device for the display apparatus of claim 29, wherein the control device is coupled to an external control system, a driving voltage is applied to the first ground pin, a first signal is applied to the second ground pin through a first line of the external control system, and a second signal is applied to the third ground pin through a second line of the external control system.

45. An integrated circuit chip comprising:
a memory;
a control input pin electrically coupled to a first ground pin of a connector;
a first signal input pin electrically coupled to a non-connection pin of the connector;
a second signal input pin electrically coupled to a second ground pin of the connector;
a digital serial bus controlling circuit electrically coupled to the control input pin, the first signal input pin and the second signal input pin to allow the control input pin, the first signal input pin and the second signal input pin to be electrically coupled to the memory; and
a switching circuit disposed between the second signal input pin and the digital serial bus controlling circuit so that the switching circuit controls an electrical connection between the second signal input pin and the digital serial bus controlling circuit based on a signal, the signal being applied to the switching circuit through the control input pin.

46. The integrated circuit chip of claim 45, wherein the switching circuit provides the electrical connection between the second signal input pin and the digital serial bus controlling circuit in response to the signal having an active level.

47. The integrated circuit chip of claim 46, wherein data are written in the memory by the digital serial bus controlling circuit when the signal having the active level is applied to the control input pin.

48. The integrated circuit chip of claim 45, wherein the switching circuit provides the electrical disconnection between the second signal input pin and the digital serial bus controlling circuit in response to the signal having a non-active level and data are not written in the memory by the digital serial bus controlling circuit when the signal having the non-active level is applied to the control input pin.

49. The integrated circuit chip of claim 45, wherein the switching circuit comprises a metal oxide semiconductor transistor coupled between the second signal input pin and the digital serial bus controlling circuit, and a gate electrode of the metal oxide semiconductor transistor is electrically coupled to the control input pin.

50. The integrated circuit chip of claim 45, wherein the first signal input pin receives serial data, and the second signal input pin receives a serial clock signal.

51. The integrated circuit chip of claim 45, wherein the first signal input pin receives a serial clock signal, and the second signal input pin receives serial data.

52. The integrated circuit chip of claim 45, further comprising:
an inversion signal output pin;
a first signal output pin configured to output a signal applied to the second signal input pin; and
an inverting circuit configured to invert the signal applied to the control input pin to output the inverted signal to the inversion signal output pin.

53. The integrated circuit chip of claim 52, wherein the inverting circuit comprises an inverter and an auxiliary inverter, the auxiliary inverter being electrically coupled in parallel with the inverter and in a reverse direction to the inverter.

54. An integrated circuit chip comprising:
a memory;
a control input pin electrically coupled to a first ground pin of a connector;
a first signal input pin electrically coupled to a second ground pin of the connector;
a second signal input pin electrically coupled to a third ground pin of the connector;
a digital serial bus controlling circuit electrically coupled to the control input pin, the first signal input pin, the second signal input pin, and the memory;
a first switching circuit disposed between the first signal input pin and the digital serial bus controlling circuit so that the first switching circuit controls the electrical connection between the first signal input pin and the digital serial bus controlling circuit based on a signal that is applied to the first switching circuit through the control input pin; and
a second switching circuit disposed between the second signal input pin and the digital serial bus controlling circuit so that the second switching circuit controls the electrical connection between the second signal input pin to the digital serial bus controlling circuit based on a signal that is applied to the second switching circuit through the control input pin.

55. The integrated circuit chip of claim 54, wherein data are written in the memory by the digital serial bus controlling circuit when the signal having an active level is applied to the control input pin, and the data are not written in the memory by the digital serial bus controlling circuit when the signal having an non-active level is applied to the control input pin.

56. The integrated circuit chip of claim 54, wherein the first switching circuit comprises a first metal oxide semiconductor transistor coupled between the first signal input pin and the digital serial bus controlling circuit, and a gate electrode of the first metal oxide semiconductor transistor is electrically coupled to the control input pin.

57. The integrated circuit chip of claim 54, wherein the second switching circuit comprises a second metal oxide semiconductor transistor coupled between the second signal input pin and the digital serial bus controlling circuit, and a gate electrode of the second metal oxide semiconductor transistor is electrically coupled to the control input pin.

58. The integrated circuit chip of claim 54, wherein the first signal input pin receives serial data, and the second signal input pin receives a serial clock signal.

59. The integrated circuit chip of claim 54, wherein the first signal input pin receives a serial clock signal, and the second signal input pin receives serial data.

60. The integrated circuit chip of claim 54, further comprising:
an inversion signal output pin;
a first signal output pin configured to output a signal applied to the first signal input pin;
a second signal output pin configured to output a signal applied to the second signal input pin; and
an inverting circuit configured to invert the signal applied to the control input pin to output the inverted signal to the inversion signal output pin.

61. The integrated circuit chip of claim 60, wherein the inverting circuit comprises an inverter and an auxiliary inverter, the auxiliary inverter being electrically coupled in parallel with the inverter and in a reverse direction to the inverter.
